(19) United States
(12) Patent Application Publication
(10) Pub. No.: US 2006/0156363 A1
(43) Pub. Date: Jul. 13, 2006

(54) File storage for scalable media

(75) Inventors: Feng Wu, Beijing (CN); Xiaoyan Sun, Beijing (CN); Gang Bai, Beijing (CN); Bin Zhu, Edina, MN (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/170,765

(22) Filed: Jun. 29, 2005

Related U.S. Application Data
(60) Provisional application No. 60/642,192, filed on Jan. 7, 2005.

(51) Int. Cl. H04N 7/173; H04N 5/76; H04N 7/16

(52) U.S. Cl. 725/113; 348/231.3; 725/135; 725/112

(57) ABSTRACT

Exemplary generic file storage for scalable media is described. In one implementation, stored scalable media streams are related as nodes of a directed acyclic graph (DAG) in which directed edges between the nodes describe relationships between scalable media streams. Many different presentations of a media content can be delivered from a DAG storage file. Data space is reduced because different presentations can avail of the same sub-trees in the DAG. In one implementation, exemplary DAG storage files for scalable media have an information structure that allows the DAG file to self-tailor and/or allocate the scalabilities of the media content presentations it is capable of delivering in order to suit the characteristics of a requesting entity.

### RELATED APPLICATIONS

The present application claims priority to U.S. Provisional Patent Application No. 60/642,192 to Feng Wu et al., entitled, “File Storage for Scalable Media,” filed Jan. 7, 2005.

### BACKGROUND

Digital media has become an indispensable part of daily life due to rapid development and wide adoption of handy digital media capturing/recording devices, rich digital media contents, portable media devices, and versatile sharing/distribution networks. In general, the digital media is stored in devices and delivered over networks in a compressed form. The quest to enable seamless media experiences over different devices and networks poses a great challenge for current media compression, storage and delivery techniques.

Conventionally, an elegant solution to the problem of providing seamless media over different devices and networks is compression of the digital media into a scalable stream. The flexibility of the scalable stream allows digital media to flow freely like water from one device to another through both wired and wireless networks, without the obstacles and hassles of transcoding. In a scalable stream, smaller subsets of the stream produce the presentations at lower frame rates, resolutions, qualities, etc. Different subsets extracted from the full stream can readily accommodate a variety of users according to their computational power, network bandwidth, display capacity, and so on.

There are various kinds of scalability depending on the type of media—that is, many different attributes or characteristics of content playback can be scaled. “Quality” scalability, for example (also referred as SNR scalability), progressively increases the reconstructed quality as more and more bits are included. Quality scalability is appropriate for almost any kind of media, such as video, image, and audio. Temporal (or “frame rate”) scalability provides different visual smoothness of the reconstructed media, and is mainly appropriate for video media. Resolution scalability (also referred as spatial scalability) provides different visual sizes of reconstructed media, and is appropriate for video and image media.

Bit-depth scalability provides reconstructed media with different precisions for each sample, for example, it can provide scalable coding both from different extension profiles, e.g., 4:2:0, 4:2:2, 4:4:4, etc.; and/or from different sampling rates, e.g., 8-bit sampling (8 bps—bit per sample), 10 bps, 12 bps, etc., for video and image media. For audio media, scalability concerns only the number of bits per each sample.

Channel scalability provides the reconstructed media on different numbers of channels. This often means the coding can be scaled from mono, stereo, 5.1 channel surround sound, to 7.1 channel surround sound, etc. Multi-view video and image scalable coding can also be categorized into channel scalability. Frequency scalability provides different fineness of frequency for the reconstructed media. It is mainly appropriate for audio.

Many approaches have been developed to achieve the scalabilities described above. The MPEG-2 standard provides for quality, temporal and spatial scalabilities for compliant streams. Quality and spatial scalabilities are explicitly defined in the SNR and spatial profiles. Temporal scalability is implicated in the main profile by including B frame coding. FIG. 1, for example, depicts the conventional structure of the temporal, quality and spatial coding in MPEG-2. The temporal scalability is achieved by dropping B frames. Another layer stream known as the enhancement layer is used to achieve the quality or spatial scalabilities. In general, the enhancement layer has higher resolution or is quantized with smaller step size. Each enhancement frame is dependent both on reference frames in the same layer and on the temporally corresponding frame in the base layer.

Since the enhancement layer in MPEG-2 uses motion compensation and also conventional quantization, the enhancement data of each frame cannot be arbitrarily truncated or dropped. Thus, the schema only provides a limited capacity for bit rate adaptation. To solve this limitation, the MPEG-4 FGS (fine granularity scalability) standard adopted a partial motion compensation schema as shown in FIG. 2, striking a compromise between coding efficiency and fine granularity scalability. The enhancement layer encoding 202 is an open-loop structure without motion compensation. The residues between source video and the reconstructed base layer 204 video form the enhancement layer stream 202 with the bit plane coding. Each bit plane contains increasingly more detailed data to enhance the base layer 204. The decoded quality of video is thereby improved with each bit plane. The rectangular boxes in FIG. 2 (e.g., 206) indicate all generated bits of the base layer 204 and the enhancement layer 202 in each picture, and the shadow regions indicate actual transmitted and decoded bits.

Recently, wavelet-based scalable video coding has been extensively investigated in MPEG-21 SVC, where the wavelet transform is applied along the temporal axis of a video sequence. In this manner, dependence among frames is exploited by the temporal wavelet decomposition instead of MC prediction. With the inherent scalable property of the wavelet transform, the wavelet video coding can simultaneously achieve scalability in both quality and resolution—features that are very desirable in video streaming and storage applications. If bit-plane coding is used, it can also contain quality scalability simultaneously. Support is provided for three spatial resolutions (QCIF, CIF and 4CIF), three frame rates (7.5 Hz, 15 Hz and 30 Hz) and two quality layers for each combination of spatial resolution and frame rate in a SVC video media. Such scalable video data is depicted as in FIG. 3. Each higher resolution stream depends on the lower resolution one, each higher frame rate stream depends on the lower one and each higher quality stream depends on the lower quality one. The base layer is the lowest quality stream with QCIF and 7.5 Hz.

Besides the scalable video coding schemata mentioned above, JPEG 2000 is a scalable image coding schema based on wavelet transform. With bit-plane arithmetic coding, it endeavors to combine quality scalability and resolution scalability in a common format, to enable distribution and viewing over a variety of connections and devices. MPEG-4 also provides fine-grain scalable audio coding with its quality and channel scalabilities. It uses bit-sliced arithmetic coding in combination with advanced audio coding (AAC).

Although there are many ways to convert digital media into scalable streams, the mainstream file formats, such as MP4, 3GPP, etc., do not support scalable media very well, due to lack of objects to describe some key relationships for generically scaling media.

### SUMMARY

Exemplary generic file storage for scalable media is described. In one implementation, stored scalable media streams are related as nodes of a directed acyclic graph (DAG) in which directed edges between the nodes describe relationships between scalable media streams. Many different presentations of a media content can be delivered from a DAG storage file. Data space is reduced because different presentations can avail of the same sub-trees in the DAG In one implementation, exemplary DAG storage files for scalable media have an information structure that allows the DAG file to self-tailor and/or allocate the scalabilities of the media content presentations it is capable of delivering in order to suit the characteristics of a requesting entity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram of conventional types of media scalabilities.

FIG. 2 is a diagram of conventional MPEG fine granularity scalability (FGS and FGST).

FIG. 3 is a block diagram of conventional scalabilities.

FIG. 4 is a diagram of exemplary file storage for scalable media.

FIG. 5 is a diagram of an exemplary scalable media directed acyclic graph (DAG) storage file.

FIG. 6 is a diagram of another exemplary scalable media directed acyclic graph (DAG) storage file.

FIG. 7 is a diagram of rate-distortion data entries in a scalable media stream.

FIG. 8 is a flow diagram of an exemplary method of making and using file storage for scalable media.

FIG. 9 is a flow diagram of an exemplary method of attaching data objects to nodes of a scalable media DAG file in order to facilitate scaling and delivery of media content.

### DETAILED DESCRIPTION

Overview

The systems and methods described herein provide a generic file format to carry scalable media contents consisting of numerous interrelated scalable media streams. Besides having the capacity to store many different types of scalable media streams, the generic file format has many other attractive features.

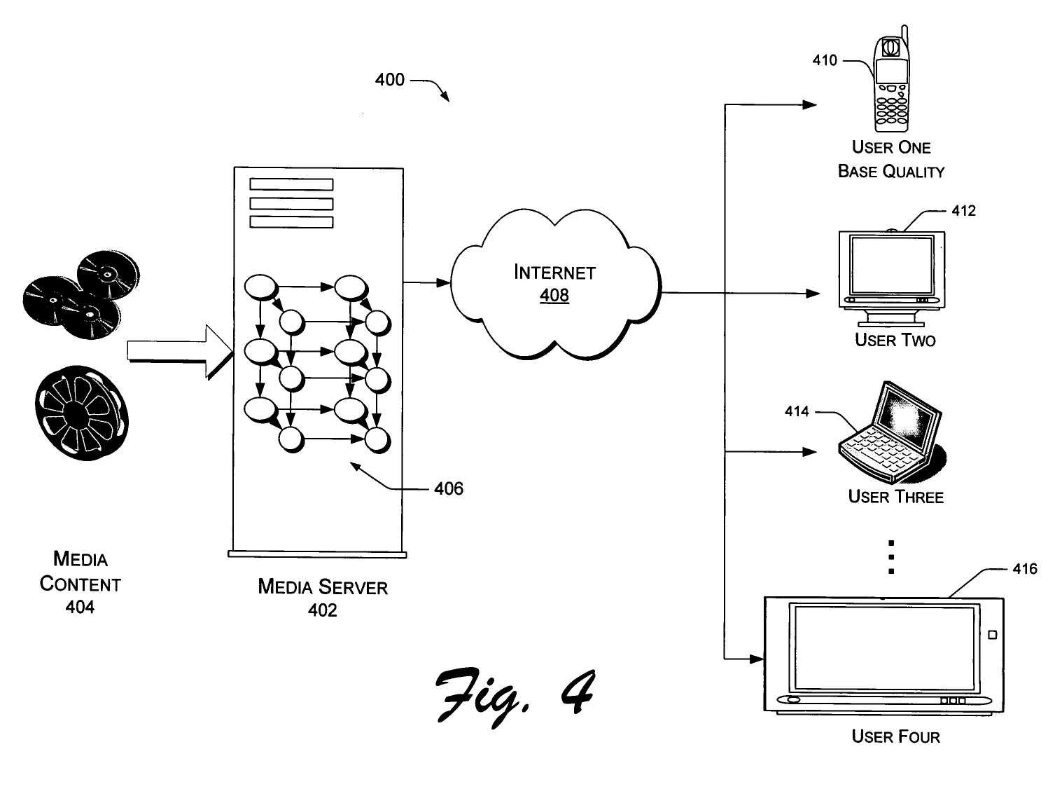

FIG. 4 shows an exemplary system 400 that uses the exemplary generic file format for scalable media. A computing device, such as a media server 402, receives and stores media content 404. The exemplary data file that results from the exemplary generic file format for formatting and storing scalable media streams is a directed acyclic graph (DAG) referred to herein as a “scalable media DAG file” 406, “exemplary DAG file” 406, etc.

When many scalable media streams are stored in the file format of such an exemplary scalable media DAG file 406, the stored streams can provide different media contents to many different types of devices and platforms and with many different scaled attributes and features. For, example, a media server 402 providing content via the Internet 408 can provide different presentations of the same video clip to a cell phone 410, a low-resolution television 412, a laptop computer 414, and a high definition television 416. Each different device receives a different combination of streams and/or scalabilities to suit the quality, bit rate, etc., appropriate for the device and the user's privileges. That is, the media content provided to each particular device or platform is simultaneously scalable across numerous characteristics of the media content being provided.

The exemplary generic file format of an exemplary scalable media DAG file 406 efficiently and thoroughly supports scalable media contents, by supporting objects that describe dependency relationships between related media streams; scalable media properties; and scalable media rate-distortion properties. The exemplary generic file format also dramatically collapses the amount of data to be stored, for example, by eliminating all but one copy of streams that are common to many different presentations of the media content.

An exemplary scalable media DAG file 406 establishes logical relationships between various streams so that, when the DAG file 406 is addressed by a user or an application to provide media content, the various scalable streams included in the DAG file 406 can be combined to provide the requested presentation scaled as requested. In other words, an exemplary scalable media DAG file 406 can be set up to supply media content that is scaled in many different ways to satisfy numerous different types of requests from various different devices. But further, the exemplary scalable media DAG file 406 efficiently collapses the numerous media streams that would be needed to meet so many different types of requests into a minimum number of streams.

The exemplary generic file format of the scalable media DAG file 406 aims to be agnostic of the type of media. That is, the exemplary generic file format can be applied universally to numerous scalable media types, as long as the scalable media conform to certain loose restrictions on the encoding structure, allowing them to be carried by the exemplary file format. Before giving a detailed description of the generic file format for scalable media, two important concepts used in building an exemplary scalable media DAG file 406, “presentation” and “ensemble,” are introduced next.

A scalable media consists of one or more scalable or non-scalable streams that are combined to represent the media. A scalable stream is a media stream that allows reshaping manipulations directly on the compressed data in order to adapt to network bandwidth fluctuations or to different device capacities. Streams associated with a scalable media may be grouped into different sets to offer different presentations for the media. For example, a scalable video may be presented at different frame sizes (say 176×144, or 352×288) and at different frame rates, say 15 frames per second (fps) or 30 fps. Each way that a scalable media is presented to a user or application for consumption is called a “presentation” of the scalable media. Each presentation is associated with a set of streams. A set that offers a valid presentation is called a presentation group. For scalable media, each presentation may be also scalable. For example, the remaining streams after removing one stream from a presentation can be another valid presentation. Data blocks for a stream in a presentation may also be dropped or scaled. A particular stream can be included in more than one presentation group.

An important feature of a presentation is that all the streams in a presentation group, as a whole, can be decoded to offer a valid presentation of the underlying media to a user or application. Thus, as a general rule, a presentation typically never depends on streams outside its presentation group to be decodable. It is worth noting that an arbitrary set is not usually a valid presentation group. For example, a set of frame-size enhancement streams does not make a presentation group since this set depends on another stream outside the set, i.e., the base stream, to be decodable. As a consequence, when a presentation is chosen for a scalable media, all the streams to be included in the presentation group are typically sent to a single decoder for decoding.

The other important concept introduced above for building an exemplary generic file format, “ensemble,” describes a collection of streams associated with a single type of media such that any presentation group for the media is either fully inside the ensemble or completely outside the ensemble. A presentation group is not allowed to contain some streams from one ensemble and other streams from another ensemble. It is also illegal to have a stream inside more than one ensemble. An ensemble is meant to be created by a single encoder and decoded by a single decoder.

As discussed above, an important feature of scalable media is that the scalable media usually consists of multiple layered streams. Thus, how to compactly and accurately describe the relationships between layered streams is a first issue. It is very helpful for applications to be able to readily select the desired layered streams according to their presentations, i.e., layered streams addressable by their presentation. Another important feature of scalable media is that each layered stream in a scalable media can usually be truncated to suit current network bandwidth and device capacity. Thus, how to optimally truncate data among layered streams is a second issue. It is helpful to applications to be able to properly allocate available bandwidth to each selected layered stream. Therefore, in order to develop the exemplary generic file format for scalable media, especially in a manner that is media agnostic, the generic file format adopts a model that takes these two issues into account.

Exemplary Generic Scalable File Format

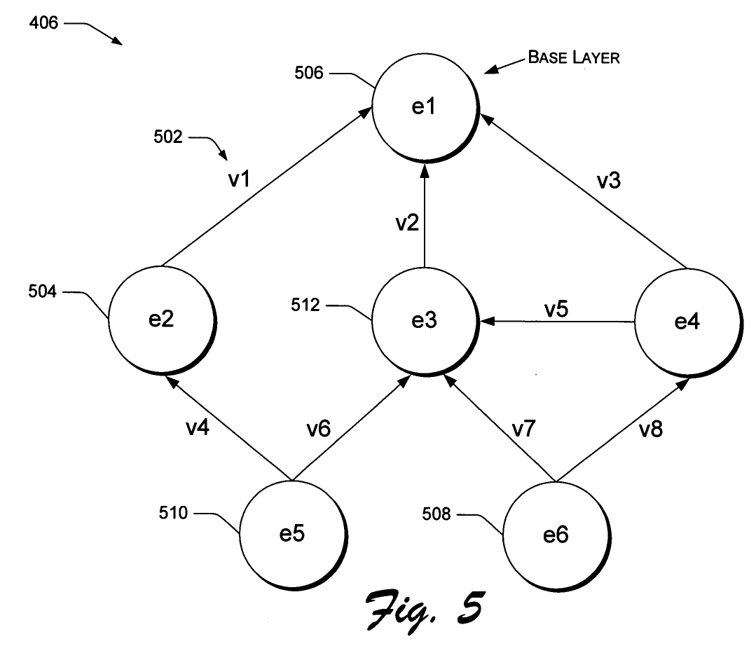

FIG. 5 shows an exemplary format of the exemplary scalable media DAG file 406, i.e., for storing and accessing scalable media on a computing device. The exemplary scalable media DAG file 406 “G,” which has no cycles, consists of a set of directed edges {V} (e.g., 502) and a set of nodes {E} (e.g., 504), i.e., G={V, E}, V={v₁, v₂, . . . , v_{N}} and E={e₁, e₂, . . . , e_{M}}. (A node is also known as a vertex of the graph.) There is no directed path starting and ending on the same node eᵢ in this implementation because such a usage does not make sense for media data.

Each node 504 indicates a layered stream making up part of a scalable media content. A node 504 also contains the stream properties (e.g., frame rate, size, quality, etc.) and other scaling information (e.g., reshaping type). Each edge 502 describes the dependency relationship of two streams, with a weighting factor. No matter what type of dependency exists between nodes (streams), if a stream e₁ is dependent on another stream e₂, the stream e₂ exists in a presentation group if and only if stream e₁ exists too. Since each layered stream may provide a different contribution for different presentations in terms of reconstructed distortion, the value vᵢ is also adopted as a weighting factor between a layered stream and one of its dependent streams. For instance, vᵢ from a QCIF stream to another QCIF stream usually has a larger value than that from a QCIF stream to a CIF stream.

There is generally only one node 506 in the generic scalable file format of the scalable DAG file 406 that has no output edge. This node 506 is usually considered to be the base layer node 506. If more than one such node appears in the generic file format, the two nodes with no output edges should be separated into two independent scalable ensembles. Although this separation may cause some data overhead, the separation into independent ensembles significantly reduces complexity of the generic file format for scalable media.

A directed acyclic graph (DAG) is a generalization of multiple trees in which certain sub-trees can be shared by different parts of the tree as a whole. In a tree with many identical sub-trees, this leads to a drastic reduction in data space requirements characteristic of the exemplary scalable media DAG file 406. To request a presentation, that is, for a specified frame rate, size, quality, color, frequency, channel, view, and so on, a node in the DAG file 406 with properties matching the desired presentation is selected. For example, if the node e₆ 508 is selected, a directed tree T={e₆, e₄, e₃, e₁} from the selected node 508 to the base layer node 506 can be derived from the DAG file 406. Parsing the tree of the DAG file 406 in this manner provides all the data needed to reconstruct the specified presentation.

Presentations are not explicitly described in the generic file format model for scalable DAG files 406, but are automatically generated by the exemplary generic file format of the DAG file 406. In one implementation, the base layer 506 is the only mandatory data for scalable media that has to be included in any presentation. Non-base layer streams are added or removed from a presentation in “either-in-or-out” fashion according to the particular dependency relationships set up in an instance of a scalable media DAG file 406.

Theoretically, there might be different types and different degrees of dependency relationships among streams included in an exemplary scalable media DAG file 406. These dependencies can be chained together to form a logical tree—i.e., a sub-tree within the exemplary scalable media DAG file 406. In one implementation, however, to unambiguously describe dependency relationships in an exemplary scalable media DAG file 406, the dependency relationships used are limited to direct dependency relationships. This is shown in the following example. As shown in FIG. 5, there exist streams e₅, e₃, e₂, and e₁ with the following dependency relationships: stream e₅ 510 is dependent on streams e₃ 512 and e₂ 504 and both of these are dependent in turn on e₁ 506. These dependencies are the direct relationships among the streams. Stream e₅ 510 actually depends on stream e₁ 506 indirectly through streams e₃ 512 and e₂ 504 but the exemplary DAG file 406 does not describe such a relationship since it is not a direct dependency relationship.

In actual implementations, to determine if stream e₅ 510 should be an included stream in a presentation, it is easy to just check to see if streams e₃ 512 and e₂ 504 are already included or not. If streams e₃ 512 or e₂ 504 are not included, then stream e₅ 510 should not be included either. The media serving logic does not have to check to see whether stream e₁ 506, the base layer, is included or not, because it is always included.

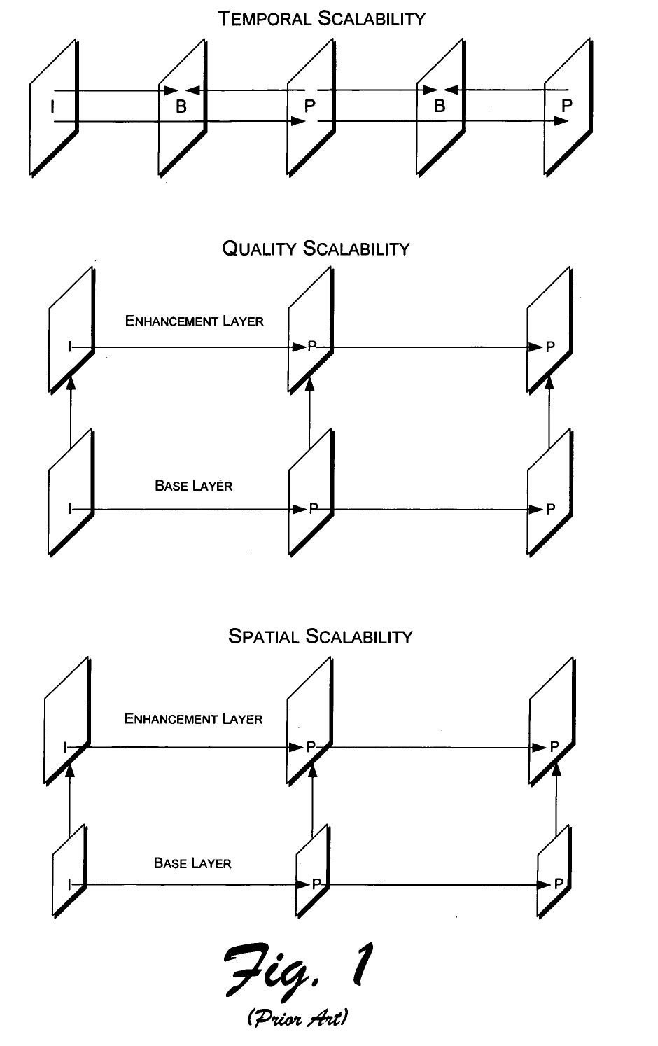

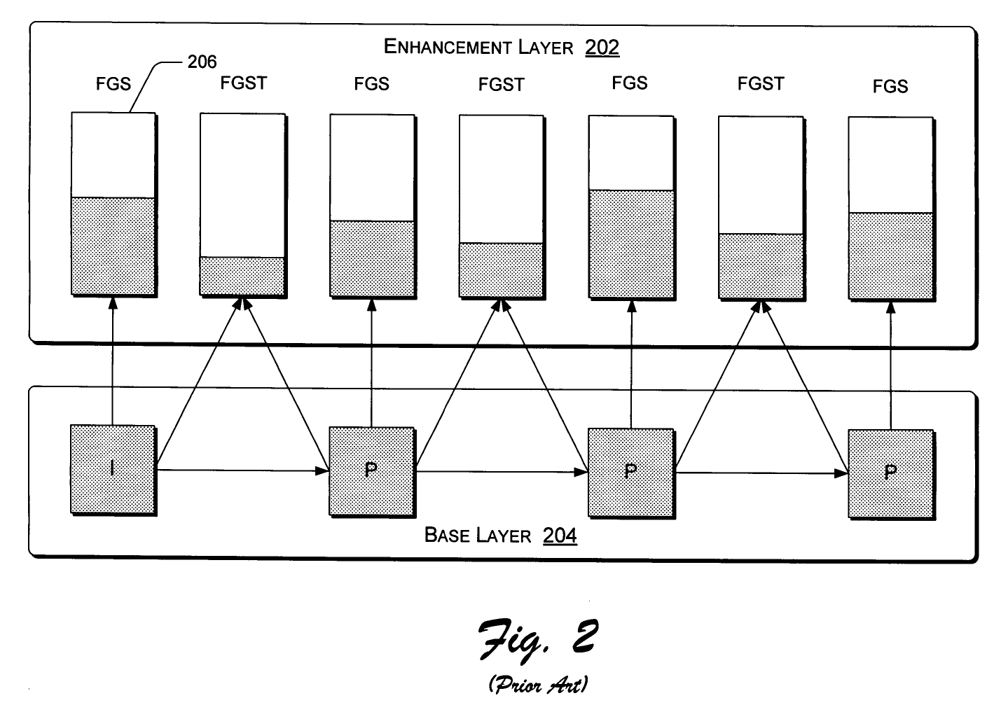

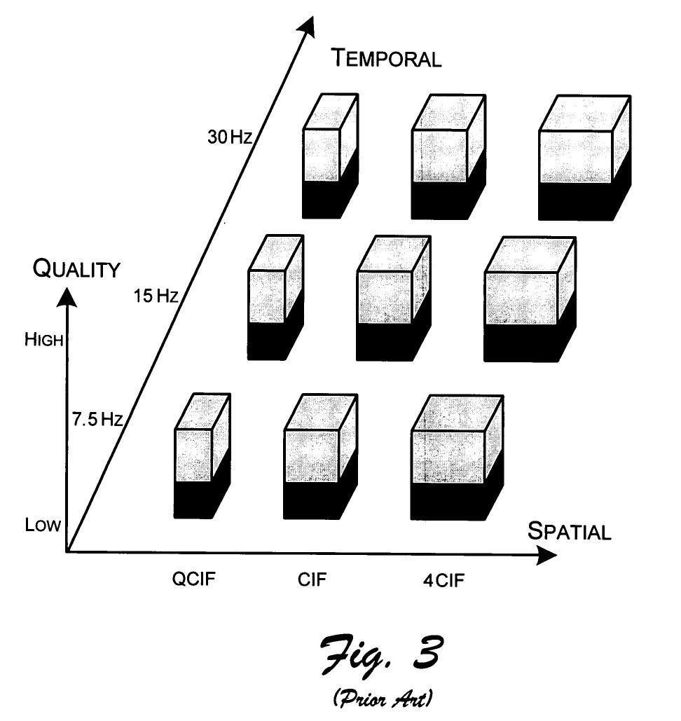

The exemplary generic file format for a scalable media DAG file 406 can readily describe and store the conventional scalable media shown in FIGS. 1 and 2. For the slightly more complex conventional case shown in FIG. 3, the exemplary DAG file of the scalable stream can be described as in Equation (1):
G={V, E} (1)
where E={e₁, e₂, . . . , e₂, e₁₈} and V={v₁, v₂, . . . , v₃₃}.

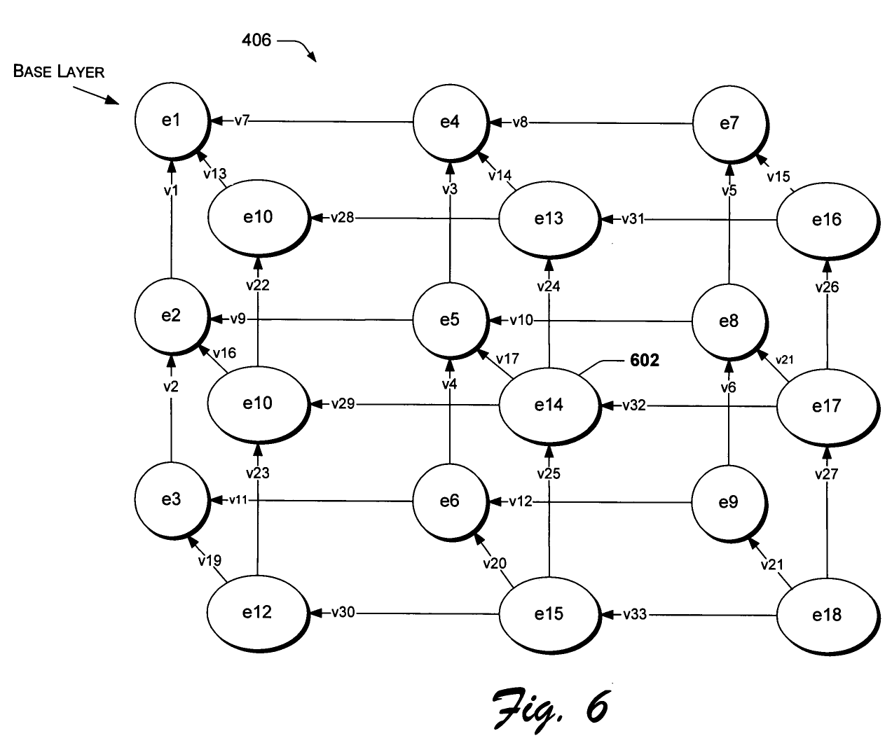

FIG. 6 shows another exemplary implementation of a DAG file 406 for storing scalable media. In one example, a presentation corresponding to node e₁₄ 602 and its dependent nodes is selected. By parsing the dependencies described within the DAG file 406, all streams for the presentation group are found: {i.e., streams e₁₄, e₁₃, e₁₁, e₁₀, e₅, e₄, e₂, e₁}.

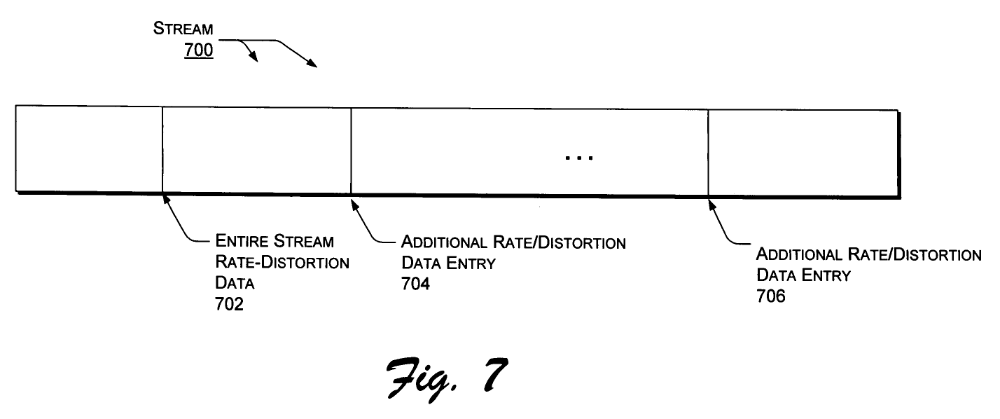

In one implementation, each layered stream corresponding to a node has an additional optional set of rate-distortion data to facilitate optimal rate allocation in one or more of the multiple layered streams selected by the parsing. In one implementation, the whole rate-distortion data consists of rate, distortion, and slope (i.e. the ratio of distortion and rate). Usually, not all the parts of the rate-distortion data are needed in many applications. Some simple rate-allocation algorithms may use only rate or slope while others may use more than one part. FIG. 7 presents an example of this association between different types of rate-distortion data and a stream 700. There may be rate-distortion data associated with an entire layered stream 702. If the stream can be truncated for fine scalability and better optimization, then a number of other rate-distortion entries can be kept (e.g., 704, 706). Each of these may contain the length of the entry (rate) and an optional slope and/or distortion value.

The weighting factor and rate-distortion data can be used together for rate allocation. For example, suppose that there are three streams e₁, e₂ and e₃, with e₂ dependent on e₁ and e₃ dependent on e₂. The weighting factor “v₁” of e₁ to e₂ is 1.2 and the weighting factor “v₂” of e₂ to e₃ is 1.5. For the presentation of e₃, the actual distortion or slope of streams is given as follows in Equations (2) and (3):
{Dₑ₁×v₁×v₂, Dₑ₂×v₂, Dₑ₃} (2)
or
{λₑ₁×v₁×v₂,λₑ₂×v₂,λₑ₃} (3)
Here, Dₑ₁, Dₑ₂, and Dₑ₃ are the individual distortion of each stream, while λₑ₁, λₑ₂, and λₑ₃ are the individual slope of each stream. The rate allocation algorithms are performed on the rate-distortion data after weighting.
Exemplary Scalable Media DAG File Schemata

Appendix A and Appendix B, which are incorporated into the detailed description of this specification, describe particular implementations of exemplary scalable media DAG files.

In appendix A, an exemplary scalable media DAG file 406 is built for use with a MICROSOFT® Advanced Systems Format (Microsoft Corp, Redmond, Wash.). In this implementation, at least two new objects are defined to support the exemplary generic file format of the exemplary scalable media DAG file 406: a “scalable dependency object” and a “scalable stream properties object.”

In Appendix B, an exemplary scalable media DAG file 406 is built for use with an International Standards Organization (ISO) base media file format schema.

Exemplary Methods

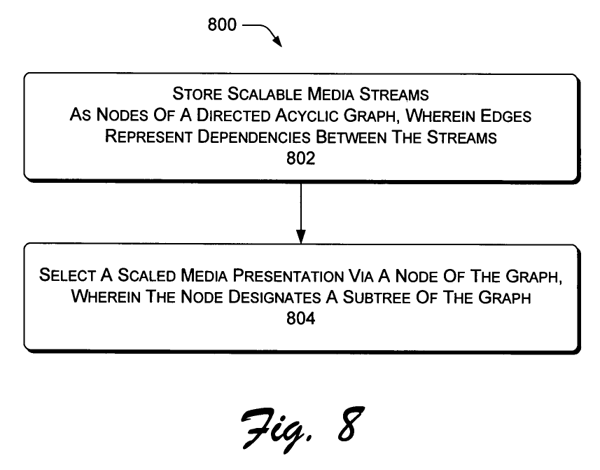

FIG. 8 depicts an exemplary method 800 of making and using exemplary file storage for scalable media. In the flow diagram, the operations are summarized in individual blocks. Parts of the exemplary method 800 may be performed by hardware, computer executable software, firmware, or combinations thereof.

At block 802, scalable media streams are stored as nodes of a directed acyclic graph, wherein edges of the graph represent dependencies between the scalable media streams being stored. When an application or a user requests a media presentation from an exemplary computer storage file that contains the scalable media streams stored with DAG relationships, the media content is available in many forms with different scaled attributes by which the media content can be delivered (e.g., the media content is available in a wide variety of qualities, resolutions, bit rates, colors, etc.).

At block 804, a particular presentation of the media content is made available by selecting a node of the DAG. The directed dependencies of the selected node can be followed until a node representing a base layer of the media content is arrived at. These path(s) designate a directed sub-tree of the DAG that represents the requested media presentation.

Because many different presentations may retrieve the same sub-tree(s) via their directed dependencies, the DAG provides a drastic reduction in data storage space.

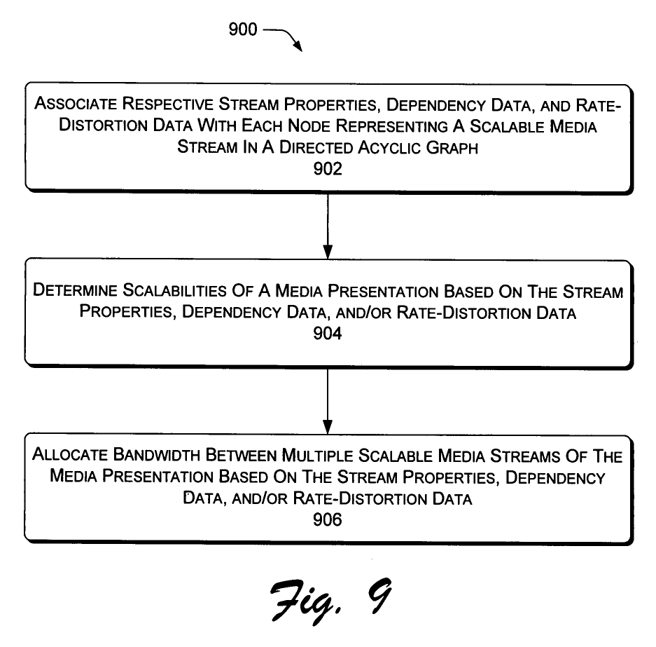

FIG. 9 depicts an exemplary method 900 of attaching data objects to nodes of a scalable media DAG file in order to facilitate scaling and delivery of media content. In the flow diagram, the operations are summarized in individual blocks. Parts of the exemplary method 900 may be performed by hardware, computer executable software, firmware, or combinations thereof.

At block 902, one or more data objects, such as a stream properties data object, a dependency data object, and/or a rate-distortion data object, etc., are associated with a node of a directed acyclic graph whose nodes represent scalable media streams. That is, information about a scalable media stream is associated with the same node that represents the scalable media stream itself in the DAG.

At block 904, information from the various data object(s) is used to determine particular scalabilities of a media presentation being requested. For example, a stream properties object may contain information that indicates that a particular node (representing a particular scalable media stream) may contribute more to one set of scalabilities for the media content than to another set of scalabilities. This may help determine whether the media stream should be included in the presentation, or, on the other hand, whether a scalability of the presentation should be changed.

When the user or the application requesting the presentation of media content has limited bandwidth, the various data object(s) may be used to allocate the bandwidth among the media streams to be included in the delivered presentation. That is, an exemplary DAG storage file has a structure that allows the DAG file to self-tailor the scalabilities of presentations that it is capable of delivering in order to suit the characteristics of the requesting entity.

CONCLUSION

The foregoing discussion describes exemplary file storage for scalable media. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### Appendix A: Implementation of an Exemplary Scalable Media Directed Acyclic Graph (DAG) Storage File for Use in the Context of MICROSOFT® Advanced Systems Format (ASF)

In this implementation, two new objects are defined to support the exemplary generic file format.

Scalable Dependency Object

The Scalable Dependency Object provides the capability for an author to identify dependencies and weighting factors between different media streams. This object can be used to express the dependency information for all media streams that comprise bands of the same media source, when using scalable audio or video codecs.

The Scalable Dependency Object may consist of a list of dependency information “structures” for each stream. A dependency information structure (in other words, a dependency record) typically contains:
Stream Number,
Dependency Type,
List of stream numbers upon which this stream depends,
List of weighting factors.

The Scalable Dependency Object is represented using the following structure shown in Table (1):

TABLE 1

| Field Name | Field Type | Size (bits) |
|---|---|---|
| Object ID | GUID | 128 |
| Object Size | QWORD | 64 |
| Records Count | WORD | 16 |
| Dependency Records | See below | ? |

where:
Object ID

Specifies the GUID for the Scalable Dependency Object. For example, the value of this field can be set to ASF_Scalable_Dependency_{—Object {}23D0F4EB-7632-4ee9-97DF-92E2F1752CB6}.

Object Size

Specifies the size in bytes of the Scalable Dependency Object. Valid values are larger than 24 bytes.

Records Count

Specifies the number of Dependency Records. This number is equivalent to the number of streams involved in this relationship.

Dependency Records

Dependency Records are described as follows in Table (2):

TABLE 2

| Field Name | Field Type | Size (bits) |
|---|---|---|
| Stream Number | WORD | 16 |
| Dependency Stream | WORD | 16 |
| Count | | |
| Dependent Stream | WORD | ? |
| Numbers | | |
| Dependent | WORD | ? |
| Weighting factors | | |
| Dependency Type | GUID | ? |

Where:

Stream Number—specifies the stream number. The stream number that does not depend on any other stream is the base layer stream. It should also have a dependency record in which the dependency stream count is equivalent to zero.

Dependent Stream Count

Specifies the number of entries in a Dependent Stream Numbers list.

Dependent Stream Numbers

Specifies a list of dependent streams. Valid values for each entry in the list are between 1 and 127.

Dependent Weighting Factors

Specifies a list of dependent weighting factors. Valid values for each entry in the list are between 1 and 65536. For example, the first byte can describe the fractional part with unit 1/256 and the second byte describes the integer part.

Dependency Type

Specifies the Dependency type. For scalable audio or video codecs, possible Enhancement GUID Values are None, Unknown, Temporal, Spatial, Quality, Color, bit-depth, View, Channel (Audio), Frequency Response (Audio). To express a dependency that requires that a stream be present in order to present another stream, an Enhancement Presentation GUID value is defined:

| | |
|---|---|
| ASF_Enhancement_None | {D6E229F8-35DA-11D1-9034-00A0C90349BE} |
| ASF_Enhancement_Unknown | {D6E229F9-35DA-11D1-9034-00A0C90349BE} |
| ASF_Enhancement_Temporal | {D6E229FA-35DA-11D1-9034-00A0C90349BE} |
| ASF_Enhancement_Spatial | {D6E229FB-35DA-11D1-9034-00A0C90349BE} |
| ASF_Enhancement_Quality | {D6E229FC-35DA-11D1-9034-00A0C90349BE} |
| ASF_Enhancement_Channels | {D6E229FD-35DA-11D1-9034-00A0C90349BE} |
| ASF_Enhancement_Frequency | {D6E229FE-35DA-11D1-9034-00A0C90349BE} |
| ASF_Enhancement_Color | {D6E229F1-35DA-11D1-9034-00A0C90349BE} |
| ASF_Enhancement_BitDepth | {D6E229F2-35DA-11D1-9034-00A0C90349BE} |
| ASF_Enhancement_View | {D6E229F3-35DA-11D1-9034-00A0C90349BE} |

The following is an example for a scalable schema that uses four audio streams. Audio stream #1 is the base stream, required in all cases, audio stream #2 enhances audio stream #1 in the frequency domain, audio stream #3 enhances the quality of audio stream #1, and audio stream #4 enhances the quality of the audio but requires audio stream #2 and #3 to be present. In this example the default sequence suggests that the enhancement provided by audio stream #2 should preferably be used over the enhancement provided by stream #3, as shown in Table (3):

TABLE 3

| | Field | |
|---|---|---|
| | Size | |
| Field Name | (bytes) | Field Value |
| Object ID | 16 | ASF_Scalable_Dependency_Object |
| Object Size | 8 | <size of this object> |
| Record Count | 2 | 4 |
| Stream Number | 2 | 1 |
| Dependent Stream | 2 | 0 |
| Count | | |
| Stream Number | 2 | 2 |
| Dependent Stream | 2 | 1 |
| Count | | |
| Dependent Stream | 2 | 1 |
| Number | | |
| Dependent Weighting | 2 | 1.25 |
| factor | | |
| Dependency Type | 16 | ASF_Enhancement_Frequency |
| Stream Number | 2 | 3 |
| Dependent Stream | 2 | 1 |
| Count | | |
| Dependent Stream | 2 | 1 |
| Number | | |
| Dependent Weighting | 2 | 1.125 |
| factor | | |
| Dependency Type | 16 | ASF_Enhancement_Quality |
| Stream Number | 2 | 4 |
| Dependent Stream | 2 | 2 |
| Count | | |
| Dependent Stream | 2 | 2 |
| Number | | |
| Dependent Stream | 2 | 3 |
| Number | | |
| Dependent Weighting | 2 | 1.125 |
| factor | | |
| Dependent Weighting | 2 | 1.0625 |
| factor | | |
| Dependency Type | 16 | ASF_Enhancement_Frequency |
| Dependency Type | 16 | ASF_Enhancement_Quality |

Scalable Stream Properties Object

Each stream of a scalable content, no matter whether it is actually scalable or not, has a Scalable Stream Properties Object (SSPO) to describe its scalability properties. An SSPO appears in the ASF Header Extension Object. It has of the following structure, as shown in Table (4):

TABLE 4

| Field Name | Field Type | Size (bits) |
|---|---|---|
| Object ID | GUID | 128 |
| Object Size | QWORD | 64 |
| Stream Number | WORD | 16 |
| Minimum Data Bit Rate | DWORD | 32 |
| Flags | WORD | 16 |
| Scalable Flag | | 1(LSB) |
| Reserved | | Rest |

where:
Object ID

Specifies the GUID for the Scalable Stream Properties Object. The value of this field is set to ASF_Scalable_Stream_Properties_Object {326C8AAE-1324-45af-B8E4-E4F158953D6E}.

Object Size

Specifies the size in bytes of the Scalable Stream Properties Object. Valid values are larger than 51 bytes.

Stream Number

Specifies the number of this stream. 0 is an invalid stream number. Valid values are between 1 and 127.

Minimum Data Bit Rate:

Specifies the minimum data rate, in bits per second, of the stream. For a scalable stream from which all the data can be dropped, this value is 0. It is required that Minimum Data Bit Rate<=Data Bit Rate defined in ESPO. Otherwise it is an error.

Scalable Property Flag (16 bits)

Scalable Flag (bit 0, LSB)

Specifies if data block is droppable or not. If the flag is enabled, data block can be dropped; otherwise it can not.

Reserved

Specifies a reserved field

R-D Data Object

The R-D data object is another high-level object for the ASF specification similar to the index object. In general, the R-D data object is only used in the server side and is not necessary to deliver to the clients. But, if the client is an edge server or proxy, the R-D data object can be optionally delivered to these. Each layered stream owns an R-D data object, an example of which is shown in Table (5):

TABLE 5

| Field Name | Field Type | Size (bits) |
|---|---|---|
| Object ID | GUID | 128 |
| Object Size | QWORD | 64 |
| Stream Number | WORD | 16 |
| R-D data info | WORD | 16 |
| Rate Type | | 2 (LSB) |
| Slope Type | | 2 |
| Distortion Type | | 2 |
| Reserved | | 10 |
| R-D Entries | BYTE | varies |

Object ID

Specifies the GUID for the R-D Data Object. The value of this field is set to ASF_R-D Data Object.

Object Size

Specifies the size in bytes of the R-D Data Object. Valid values are larger than 24 bytes.

R-D Data Info contains flags governing the behavior of the R-D data of the each media object as shown in Table (6). Rate Type specifies the data type of the Rate Entries.

TABLE 6

| Values | Meaning |
|---|---|
| 00 | Reserved |
| 01 | Each Rate Entry is a BYTE |
| 10 | Each Rate Entry is a WORD |
| 11 | Each Rate Entry is a DWORD |

Slope Type specifies whether there is a slope associated with each R-D entry, and the data type slope entry, as shown in Table (7):

TABLE 7

| Values | Meaning |
|---|---|
| 00 | There is no slope entry |
| 01 | Each slope entry is a BYTE. |
| 10 | Each slope entry is a WORD. |
| 11 | Each slope entry is a DWORD. |

Distortion Type specifies whether there is a distortion associated with each R-D entry,and the data type of the distortion entry as shown in Table (8):

TABLE 8

| Values | Meaning |
|---|---|
| 00 | There is no distortion entry |
| 01 | Each distortion entry is a BYTE. |
| 10 | Each distortion entry is a WORD. |
| 11 | Each distortion entry is a DWORD. |

R-D Entries

The media object may contain one or more R-D entries. The exact number (N) of R-D entries can be calculated through counting the R-D entries read in, until the entire R-D object has been parsed. Each R-D Entry takes a form, as in Table (9):

TABLE 9

| Field Name | Field Type | Size (bits) |
|---|---|---|
| Rate | BYTE/WORD/DWORD | 8, 16, 32 |
| Lambda | BYTE/WORD/DWORD | 0, 8, 16, 32 |
| Distortion | BYTE/WORD/DWORD | 0, 8, 16, 32 |

Rate

Except the last R-D entry, each R-D entry contains a rate, whose data type (BYTE/WORD/DWORD) is determined by the Rate Type Flag.

Lambda

Each R-D entry may have a lambda value, whose data type (BYTE/WORD/DWORD) is determined by the Lambda Type Flag.

Distortion

Each R-D entry may have a distortion value, whose data type (BYTE/WORD/DWORD) is determined by the Distortion Type Flag.

### Appendix B: Implementation of an Exemplary Scalable Media Directed Acyclic Graph (DAG) Storage File in the Context of an International Standards Organization (ISO) Base Media File Format

In order to support scalable media in ISO base media file format, some new boxes and fields are defined here. This implementation contains three schemata to extend ISO base media file format. The differences among them are concern how to organize scalable layered streams, samples, and NAL (Network Abstraction Layer) units.

Schema A

An entire scalable stream, which is managed by a single track, is composed of a sequence of contiguous NAL units. In this schema, each NAL unit of a certain layered stream is equal to a layered sample. All layered samples simultaneously belong to a sample. Meanwhile, NAL units or layered samples of a layered stream are categorized as a layered sample group. But this implementation borrows the sample group, which has been defined in the ISO base media file format, to manage a layered sample group instead of defining a new box. In addition, this implementation defines a new box (Scalable Layer Description Entry) to describe the properties and dependencies of each layered stream and another box (Salable Layer Sample Information) to describe the rate-distortion (R-D) information of each NAL unit or a layered sample.

Scalable Layer Description Entry

BoxTypes: ‘slde’
Container:
   Sample Group Description Box (‘sgpd’)
Mandatory: No
Quantity: Zero or more

This box describes the relationship of each layered stream and its properties such as R-D type information, frame rate and bit rate.

Syntax:

```
aligned(8) class RDTypeInfo{
  bit(2) rate_type;
  bit(2) slope_type;
  bit(2) distortion_type;
}
aligned(8) class ScalableDependencyInfo {
  unsigned int(16) layerNumber;
  unsigned int(32) dependency_type;
  unsigned int(16) dependent_weighting_factor;
}
aligned(8) class ScalableLayerEntry( ) extends VisualSampleGroupEntry
(‘slde’) {
```

| | |
|---|---|
| unsigned int(8) | layerNumber; |
| unsigned int(16) | avgBitRate; |
| unsigned int(16) | avgFrameRate; |
| unsigned int(32) | width; |
| unsigned int(32) | height; |

| | |
|---|---|
| unsigned int(8) | truncateFlag |
| RDTypeInfo | typeInfo; |

| | |
|---|---|
| unsigned int(8) | dependencyCount; |
| ScalableDependencyInfo | dependency[dependencyCount]; |
| } | |

Semantics:

RDTypeInfo this class contains the flags governing the behavior of the R-D information.

Rate_type specifies the data type of the rate in the RDEntry, as shown in Table (10):

TABLE (10)

| Values | Meaning |
|---|---|
| 00 | Reserved |
| 01 | Each Rate data is a BYTE |
| 10 | Each Rate data is a WORD |
| 11 | Each Rate data is a DWORD |

Slope_type specifies whether there is a slope associated with each R-D entry, and the data type of the slope in the RDentry, as shown in Table (11):

TABLE (11)

| Values | Meaning |
|---|---|
| 00 | There is no slope data |
| 01 | Each slope data is a BYTE. |
| 10 | Each slope data is a WORD. |
| 11 | Each slope data is a DWORD. |

Distortion_type specifies whether there is a distortion associated with each R-D entry, and the data type of the distortion in the RDEntry, as shown in Table (12):

TABLE (12)

| Values | Meaning |
|---|---|
| 00 | There is no distortion data |
| 01 | Each distortion data is a BYTE. |
| 10 | Each distortion data is a WORD. |
| 11 | Each distortion data is a DWORD. |

ScalableDependencyInfo contains the dependencies among layers.

LayerNumber This non-negative integer indicates the number of a layer, with the base layer being numbered as zero and all enhancement layers being numbered as one or higher.

dependency_type are defined: ‘unel’ (unknown enhance layer), ‘teel’ (temporal enhance layer), ‘spel’ (spatial enhance layer), ‘quel’ (quality enhance layer).

dependent_{—weighting}_factor specifies a dependent weighting factor. A valid value is between 1 and 65536. The first type describes the factional part with unit 1/256 and the second byte describes the integer part.

avgbitRate gives the bit rate that the layer combined with other dependent layers can present without any truncation.

avgFrameRate gives the frame rate that the layer combined with other dependent layers can present.

width gives the width of a picture that the layer combined with other dependent layers can present.

height gives the height of picture that the layer combined with other dependent layers can present.

truncateFlag marks whether this layer can be truncated. If this layer can be truncated, then truncateFlag is set to 1.

typeInfo gives the type of rate, distortion and slope value of the slope in RDEntry and the type of NAL_slope and NAL_distortion.

dependencyCount gives the number of layers that the current layer is dependent on.

Dependency is an array of DependencyInfo structure giving the depended layer number, dependency type and dependent_weighting_factor.

Layered Sample Information Box

Box Types: ‘Irif’
Container: Sample Table Box(‘stbl’)
Mandatory: No
Quantity: Zero or more

This box contains R_D information of each layered sample.

Syntax:

```
aligned (8) class RDEntry( ){
  unsigned int(8/16/32) Rate;
  unsigned int(0/8/16/32) Slope;
  unsigned int(0/8/16/32) Distortion;
}
aligned (8) class layeredSampleInfoBox extends FullBox(‘lrif’, version =
0, 0){
  int i,j,k;
  for (i=0; i < sample_count; i++) {
    unsigned int(16) layeredsample_count;
    for (J=0; j < layeredsample_count; j++) {
      unsigned int(16) RDEntryCount;
      for (k=0; k < RDEntryCount; k++){
        RDEntry RDInfo;
      }
    }
  }
}
```

Semantics:

rate gives the rate data of a R-D point in a layered sample. The size can be BYTE, WORD and DWORD which specified by typeInfo.

slope gives the slope data of a R-D point in a layered sample. The size can be 0, BYTE, WORD and DWORD which specified by typeInfo.

distortion gives the distortion data of a R-D point in a layered sample. The size can be 0, BYTE, WORD and DWORD which is specified by typeInfo.

sample_count is an integer that gives the number of samples in the track which can be found in sample description box (‘stsd’) defined by ISO base media file format.

Iayered_{—sample}_count is an integer that gives the number of layered samples in a sample.

RDEntryCount is an integer specifying the number of R-D Entries of this layered sample.

RDInfo contain the rate, slope and distortion information of a layered sample.

Schema B

An entire scalable stream, which is managed by a single track, is composed of a sequence of contiguous NAL units. Similar to schema A, each sample consists of NAL units of all layered streams at the same time. Since different layered streams have different frame rate and bit rate, different samples may contain different NAL units. In schema B, the implementation categorizes the samples with the same NAL structure as a sample group. The NAL units belonging to different layered streams in a sample are managed as sub samples, which have been defined in the ISO base media file format. This implementation defines a new box (Scalable Layer Description Entry) to describe the properties and dependency of each layered stream, and another box (Scalable Sub Sample Information) to describe the R-D information of each sub sample.

Scalable Layer Description Entry

Box Types: ‘side’
Container: Sample Group Description Box (‘sgpd’)
Mandatory: No
Quantity: Zero or more

This box defines which layers are contained in a group and their dependencies.

Syntax:

```
aligned(8) class ScalableLayerEntry( ) extends VisualSampleGroupEntry
(‘svcl’) {
    unsigned int(8) layer_count;
    for (i=0; i<layer_count; i++) {
        unsigned int(8) layerNumber;
  }
    unsigned int(1) layer_definitions_present;
    unsigned int(7) reserved = 0;
    if (layer_definitions_present) {
        unsigned int(8) total_layer_count;
        for (i=0; i<total_layer_count; i++) {
      unsigned int(8) layerNumber;
            unsigned int(16) avgBitRate;
            unsigned int(16) avgFrameRate;
      unsigned int(32) width;
      unsigned int(32) height;
      unsigned int(8) truncateFlag;
      RDTypeInfo  typeInfo;
      unsigned int(8) dependencyCount;
      SVCDependencyInfo  dependency[dependencyCount];
            }
    }
}
```

Semantics:

layerNumber: this non-negative integer indicates the layer number of the layer, with the base layer being numbered as zero.

layer_definitions_present: Indicates the presence of layer definitions in this group definition.

total_layer_count: Indicates the total number of layers mentioned in all groups.

The other fields are defined as that in Scheme A.

Scalable Sub Sample Information Box

Box Types: ‘sssi’
Container: Sample Table Box (‘stbl’) or Track Fragment Run Box (‘trun’)
Mandatory: No
Quantity: Zero or more

This box contains R_D information of each sub sample in a sample.

Syntax:

```
aligned (8) class SVCSubSampleInfoBox extends FullBox(‘svcs’,
version = 0, 0){
  int i,j,k;
  for (i=0; i < sample_count; i++) {
    unsigned int(16) subsample_count;
    for (j=0; j < subsample_count; j++) {
      unsigned int(8) layerNumber;
      unsigned int(16) RDEntryCount;
      for (k=0; k < RDEntryCount; k++){
        RDEntry RDInfo;
      }
    }
  }
}
```

Semantics:

subsample_count is an integer that specifies the number of sub-samples for the current sample.

layerNumber is the layer number of a layer which the sub sample belongs to.

The other fields are defined as in Schema A.

Schema C

An entire scalable stream is managed by multiple tracks. NAL units belonging to different layered streams are categorized as different tracks. The implementation defines a new box (Scalable Track Properties Box) to describe the dependency of different streams and another box (sample R-D information box) to describe the R-D information.

Sample R-D Information box

Box Types: ‘srdi’
Container: Sample Table Box(‘stbl’)
Mandatory: No
Quantity: Zero or one

This box defines the R-D information of each sample in a track.

Syntax:

```
aligned (8) class sampleRDInfoBox extends FullBox(‘rdif’, version =
0, 0) {
    int i,j;
  for (i=0; i < sample_count; i++) {
    unsigned int(16) RDEntryCount;
    for (j=0; j < RDEntryCount; j++){
      RDEntry RDInfo;
    }
  }
}
```

Semantics:
The fields are defined as in Schema A.
Scalable Track Properties Box
Box Types: ‘sctp’
Container: Track Box (‘trak’)
Mandatory: No
Quantity: Zero or one

This box defines the dependency among different tracks in a svc_group.

Syntax:

| aligned(8) class SVCDependencyInfo { | |
|---|---|
| unsigned int(16) dependent_track_ID; | |
| unsigned int(32) dependency_type; | |
| unsigned int(16) dependent_weighting_factors; | |
| } | |
| aligned(8) class ScalableTrackPropertiesBox extends Box(‘sctp’) { | |
| unsigned int(32) | svc_group; |
| if (svc_group != 0){ | |
| unsigned int(32) | avgbitrate; |

```
    unsigned int(8)  truncateFlag;
    RDTypeInfo  typeInfo;
    unsigned int(16) dependent_track_count;
    SVCDependencyInfo dependency[dependent_track_count]
  }
}
```

Semantics:

dependent_{—track}_ID is an integer that provides a dependency from the track which is referred by track_ID to another track in the presentation.

svc_group indicates the number of svc group. It is 0 if the track is not intended for scalable video coding

dependent_track_count is an integer that gives the number of dependent tracks.

The other fields are defined as in Schema A.

1. A method, comprising:
identifying multiple scalable streams of media content; and
representing each scalable stream as a node in a directed acyclic graph, wherein each edge between two nodes represents a dependency relationship between two of the multiple scalable streams.

2. The method as recited in claim 1, wherein each node also includes stream properties of the scalable stream represented by the node.

3. The method as recited in claim 1, wherein each node also includes rate-distortion properties of the scalable stream represented by the node.

4. The method as recited in claim 1, further comprising storing the multiple scalable streams as a storage file on a computing device, wherein the storing maintains relationships of the directed acyclic graph.

5. The method as recited in claim 1, further comprising:
identifying multiple sets of scalable media streams, wherein each set represents a different presentation of scaled media content and scaled playback characteristics; and
representing each scaled stream of each set as a node in the directed acyclic graph, wherein the nodes of each set have a dependency relationship with each other represented by the edges.

6. The method as recited in claim 5, wherein the multiple sets include common scalable streams represented by common nodes of the directed acyclic graph.

7. The method as recited in claim 6, further comprising maximizing the number of the common nodes.

8. The method as recited in claim 5, further comprising arranging the directed acyclic graph to minimize the number of nodes representing a same scalable stream.

9. The method as recited in claim 5, further comprising arranging the directed acyclic graph to eliminate storing a single scalable stream common to multiple sets more than once in the storage file.

10. The method as recited in claim 1, further comprising:
identifying ensembles, each ensemble including a collection of variously scaled presentations for a single media content and a single codec; and
arranging the directed acyclic graph such that different ensembles share no common nodes.

11. The method as recited in claim 1, further comprising addressing a set of the scalable streams by their presentation, wherein selection of one of the nodes representing the presentation also selects other dependent nodes in the set.

12. The method as recited in claim 11, further comprising allocating an available bandwidth among each selected scalable stream according to rate-distortion data stored with each selected node.

13. The method as recited in claim 11, further comprising:
assigning a weighting factor to the edges between the nodes, wherein the weighting factor is based on a degree of the dependency; and
allocating an available bandwidth among each selected scalable stream in a set according to rate-distortion data stored with each selected node factored by at least one weighting factor of an edge.

14. A data structure for a computer storage file, comprising:
a directed acyclic graph, wherein each node represents a scalable media stream and each edge between nodes represents a dependency relationship between two scalable media streams; and
data objects associated with at least some of the nodes, wherein a data object associated with a node determines at least in part the scaling of a media stream associated with the node.

15. The data structure for a computer storage file as recited in claim 14, wherein the data object associated with the node includes rate-distortion data for the scalable media stream associated with the node.

16. The data structure for a computer storage file as recited in claim 15, wherein the rate-distortion data determines at least in part an allocation of bandwidth for the scalable media stream associated with the node.

17. The data structure for a computer storage file as recited in claim 15, further comprising graph edges representing dependency relationships between media streams of a presentation set, wherein a presentation set includes multiple scalable media streams to provide scaled media content and scaled playback characteristics.

18. The data structure for a computer storage file as recited in claim 17, further comprising multiple presentation sets,
wherein the multiple presentation sets share common nodes representing common scalable media streams and
wherein graph edges from nodes of different presentation sets to a common node are weighted to represent respective contributions of the common node to each of different presentation sets.

19. The data structure for a computer storage file as recited in claim 18, wherein the directed acyclic graph is arranged to maximize the number of common nodes shared by multiple presentation sets.

20. A system, comprising:
means for arranging scalable media streams for computer storage according to relationships of a directed acyclic graph, wherein each node represents a scalable media steam and edges between nodes represent dependencies between the scalable media streams;
means for sharing sub-trees of the directed acyclic graph among different parts of the tree to reduce data space, wherein the different parts of the tree represent differently scaled presentations of the media content; and
means for selecting a node to provide one of the presentations to an application, wherein the presentation requested by the application has scalable properties including one of a frame rate, size, quality, color, frequency, channel, and/or view represented by the node and by additional nodes dependent on the node, wherein a sub-tree of nodes representing the presentation is selected by deriving a directed tree from the selected node to a base layer node to reconstruct the presentation.
